(19) United States
(12) Patent Application Publication
(10) Pub. No.: US 2010/0042539 A1
(43) Pub. Date: Feb. 18, 2010

(54) Money Movement Network Hub System

(76) Inventors: Sanjeev Dheer, New York, CA (US); Krishna Bhagavatula, Fremont, CA (US); Behram Panthaki, Garden City, NY (US)

Correspondence Address: COURTNEY STANIFORD & GREGORY LLP, 10001 N. De Anza Blvd., Suite 300, Cupertino, CA, 95014, US

(21) Appl. No.: 12/543,501

(22) Filed: Aug. 18, 2009

Related U.S. Application Data
(60) Provisional application No. 61/089,830, filed on Aug. 18, 2008.
(60) Provisional application No. 61/187,035, filed on Jun. 15, 2009.

(51) Int. Cl. G06Q 20/00; G06Q 40/00

(52) U.S. Cl. 705/40

(57) ABSTRACT

Embodiments of the invention include an electronic payment system that allows person-to-person (P2P) payments and requests for payment, consumer-to-consumer (C2C) payments and requests for payment, and use of a P2P service by a business which in turn offers the service to its customers for making payments and requests for payment. The system and service allow users to make payments from their existing financial accounts to anyone, anywhere without funding a special account and managing a third-party relationship separate from the relationship the user has with the financial institution. The service further allows users to receive payments without registering for a third-party service. In embodiments, the service is available as an integrated banking service alongside current financial institution electronic banking services already used by customers. A bank customer can use the payment service directly from within a bank or bank web site.

### RELATED APPLICATIONS

This application claims the benefit of U.S. Provisional Patent Application Ser. No. 61/089,830, filed Aug. 18, 2008. This application also claims the benefit of U.S. Provisional Patent Application Ser. No. 61/187,035, filed Jun. 15, 2009. All of the foregoing U.S. patent applications are incorporated by reference herein.

### TECHNICAL FIELD

The invention is in the field of electronic payment methods and systems, including electronic financial networks.

### BACKGROUND

There is a growing demand among consumers and small businesses for electronically sending and receiving payments among each other. These types of transfers will be referred to herein of payments as person-to-person (P2P) payments, although the term is meant to include small-business-to-consumer or consumer-to-small business transfers as well. These payments are also sometimes referred to as consumer-to-consumer or C2C payments.

Currently, the majority of P2P transactions are conducted using cash or checks. There are however two types of electronic methods available for making these payments. One method is wire transfers. Individuals or businesses can wire money to other individuals or businesses electronically. Sending a wire transfer requires the sender to know the account information of the recipient. The sender fills in information about the recipient account and the wire transaction is initiated. The second category of electronic P2P payment methods involves sending and receiving payments using email addresses or mobile phone numbers. This payment method is of relatively recent origin and has the advantage that a sender can send money electronically to anyone using their email address or mobile phone number. The sender does not need to know the bank account number or any other type of financial account information about the recipient. One example of such email/mobile P2P services is PayPal™. Another example is Obopay™, which has similar functionality. A sender can send money to a recipient by providing the email address or the mobile phone number and either conducting the transaction in the pure personal computer (PC) based online environment, or on a mobile phone. The intended recipient, upon receiving notification of the payment, provides an account number to which the funds are then deposited. These systems have been created as “closed loop” systems in that both sender and recipient must directly establish a relationship with the system. Both sender and recipient must register directly with the service, including submitting a token e.g. email address or mobile number, and opening a financial account specific to the system. The transaction is then conducted between the two parties both of whom have financial accounts with the P2P service. In order for this system to work, each user is uniquely identified by the email address or mobile number token.

FIG. 1 is a block diagram of a prior art payment system 100. A payment service 102 is connected via one or more communications networks to funds sources such as a bank 104 and credit card services 106. The payment service 102 is also connected to various users who have each registered with the service 102 using registration module 102A. Members include persons A and D, who may communicate with the payment service 102 using a handheld device or a personal computer such as PC B. Members also include merchants such as merchant C who has online stores.

Once a user is registered with (or becomes a member of) the payment service 102 that user must fund a special user account 102B that is used to fund payments made on behalf of the user using payment process 102C. The user must register with their email address or mobile number (also referred to herein as a token). The user cannot register again with the service 102 using the token, because the token is unique. Similarly, two people with the same email address or mobile phone number cannot both be registered for the service 102. The system 100 will reject the second registrant and require that they use a different token. This feature is a core design element of the technology of systems such as system 100, and is embedded in the data architecture and the application logic. Additionally, this unique identification feature defines the control mechanisms and fraud management logic of the system 100. Hence it is a defining element of the whole service.

In such traditional systems as system 100, a user must open an account 102B with the service and the user must fund the account using an external financial source such as bank 104 or credit card 106. In addition, funds must be kept on deposit in the account 102B for transfer or disbursement. Funds from the account 102B are distributed to payees when the user performs a transaction that allows use of the service 102, including payments to merchants such as transfer A-C, or payments to individuals such as transfer A-D.

However, current systems and methods for facilitating online transactions have significant limitations. For example, settlement time for payment from the external financial source (e.g. 104 or 106) to the user account 102B can be 3 to 4 days using a demand deposit account (DDA account). When funds are transferred from the user account 102B to multiple destination accounts, an additional 3 to 4 days settlement time is incurred in transferring the funds from the destination accounts to a main bank account. This creates a worst-case settlement time of up to 8 days, not including any delays caused by verification processes at any transfer point.

Another disadvantage of such current systems is that the user must fund and manage the account 102B with the service 102 as a separate account and relationship distinct from any other payer or payee relationships.

Such direct-to-the-user or closed loop systems such as the system 100 do not serve the needs of banks or financial institutions that may want to provide their customers with access to a P2P service integrated into the current online banking or mobile banking systems in place. Also, the system 100 lacks the convenience of an anyone-to-anyone funds transfer capability according to which anyone with a financial account and a communications device can make an electronic payment to anyone else with a communications device and a financial account without requiring both parties to currently be registered members or users of a system, or to fund a special user account with the system.

There is thus a need for a payment service that allows users to make payment from their existing financial accounts to anyone, anywhere, without registering for a third-party service and funding a special account. It would be desirable for such a service to be seamlessly available as an integrated banking service alongside current financial institution electronic banking services the user already takes advantage of.

### BRIEF DESCRIPTION OF THE DRAWINGS

FIG. 1 is a block diagram of a prior art system used to facilitate making payments.

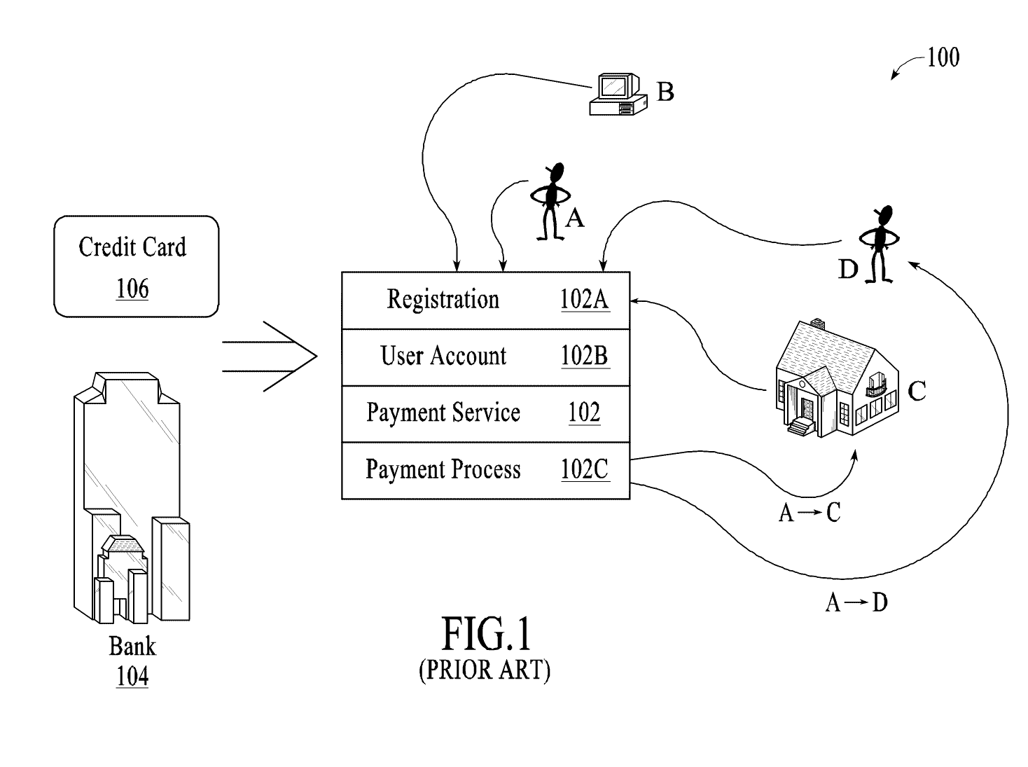

FIG. 2 is block diagram of a payment system according to an embodiment.

FIG. 3 is a block diagram illustrating the way in which the payment service is embodied in a shared, or distributed third-party architecture according to an embodiment.

FIG. 4 is a block diagram showing routing of a payment transaction by the payment service according to an embodiment.

FIG. 5 is a flow diagram of a process of making a payment according to an embodiment.

FIG. 6 is a flow diagram of a process of requesting a payment according to an embodiment.

FIG. 7 is an illustration of a user interface “send money” screen of an embodiment of the payment service.

FIG. 8 is an illustration of a user interface page presented when the user clicks an “incoming payments and alerts” tab according to an embodiment

FIG. 9 is an illustration of a user interface page presented when the user clicks an “activity” tab according to an embodiment.

FIG. 10 is an illustration of a user interface page presented when the user clicks a “scheduled payments” tab according to an embodiment.

FIG. 11 is an illustration of a user interface page presented when the user clicks a “preferences” tab according to an embodiment.

FIG. 12 is an illustration of a home page of the payment services web site according to an embodiment.

FIG. 13 is an illustration of a registration page reached by clicking the registration tab from the home page.

FIG. 14 is an illustration of a “deposit a payment” page the user goes to from the “submit” button on the registration page of FIG. 13.

FIG. 15 is an illustration of the page of FIG. 14 after the “validate email” button is clicked

FIG. 16 is an illustration of the page of FIG. 15 showing that steps “1” and “2” have been checked off and the user can now click to deposit the payment into the indicated account.

FIG. 17 is an illustration of a “confirmation page” that summarizes details of the successful deposit of the payment

FIG. 18 is an illustration of a “registration” page according to an embodiment.

FIG. 19 is an illustration of a user interface page showing the mobile phone validation step.

FIG. 20 is an illustration of a “confirmation” page showing that the registration with the payment service was successfully completed.

FIG. 21 is an illustration of a “preferences” page within the user interface of the payment service web site

### DETAILED DESCRIPTION

Embodiments of the invention include an electronic payment system that allows person-to-person (P2P) payments and requests for payment, consumer-to-consumer (C2C) payments and requests for payment, and use of a P2P service by a business which in turn offers the service to its customers for making payments and requests for payment. The system and service allow users to make payments from their existing financial accounts to anyone, anywhere without funding a special account and managing a third-party relationship separate from the relationship the user has with the financial institution. The service further allows users to receive payments without registering for a third-party service. In embodiments, the service is available as an integrated banking service alongside current financial institution electronic banking services already used by customers. A bank customer can use the payment service directly from within a bank or bank web site. For banks and financial institutions that are members of the service, the service provides additional customer loyalty and economic benefits.

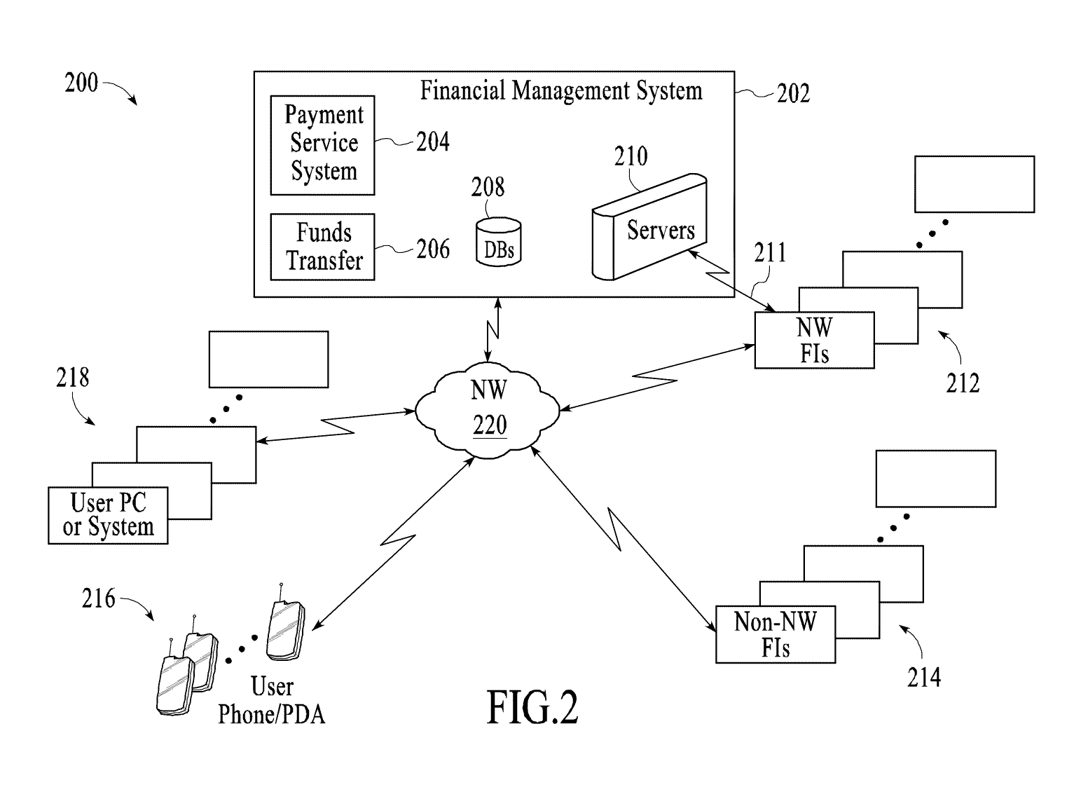

FIG. 2 is a block diagram of an electronic payment system 200 according to an embodiment. A financial management system 202 includes a funds transfer module 206, databases 208, servers 210, and a POPmoney™ service system 204. POPmoney™ is one proprietary name for an electronic payment service as described herein, but that is not intended to be limiting. In various embodiments, aspects of the financial management system, such as the funds transfer module 206, are provided by CashEdge™, Inc. of New York, N.Y. The funds transfer module is the subject of U.S. Pat. Nos. 7,383,223, 7,505,937, 7,321,875, and 7,321,874 assigned to CashEdge™, Inc. All of the foregoing U.S. patents are incorporated by reference herein.

The servers 210 include various servers coupled to network financial institutions (NW FIs) 212 via a proprietary coupling or connection 211 for the purpose of facilitating a payment service as further described below, and with reference to POPmoney service system 204. Network FIs are also referred to as member FIs or registered FIs. Member FIs have registered with the POPmoney™ service system 204 so as to be recognized as a source and destination for funds transferred according to the payment service. In embodiments as described in more detail below, member FIs include a POPmoney™ tab on their web sites for allowing their customers to make and request payments conveniently as in the course of any other online banking business. As further described, the POPmoney™ 204 service system also presents a user interface directly to users so that payments can be made and requested directly with the financial management system 202 rather than through a FI web site. The databases 208 store various information regarding different FIs, different customers or POPmoney™ users, security information, etc. The financial management system 202 communicates with multiple third-party information providers (not shown) for the purpose of obtaining information related to security and risk management, such as credit reporting agencies, government databases, etc.

The system 200 further includes multiple non-network FIs (non-NW FIs) 214. Non-NW FIs 214 can participate in the payment service by being specified as a source or destination of funds according to the payment service, even though they are not members of the service. However, it is advantageous for FIs to become members of the service so that their customers can access and manage their POPmoney™ transactions using the FI web site.

Users or customers communicate through a network 220 with FIs 212 and FIs 214 as applicable, as well as with the financial management system 202. Users can communicate using a personal computer (PC) or other, similar system 218, or using a network-capable phone or other PDA 216. As further explained below, users can receive payments using the payment service whether or not they are members of the payment service.

Embodiments include a payment system and service that is shared among banks. This shared and distributed architecture allows for a convenient user experience that facilitates email or mobile payments across different banks. This also permits payments to be routed efficiently between the customers at different banks. Users need not directly register with the payment service. The payment service is integrated into the online banking service or mobile banking service of the bank, and receives registration information directly from the bank. This information could include the account numbers that user has with the bank. In addition, it can include the registration information that the bank has about the user, such as the email address, mobile phone number and/or name, etc. Because the user registration process in the example being described is with a bank and not directly with the payment service, the payment system includes features not available in current “closed-loop” P2P systems. For example, the same user can register from multiple banks, because users are shared among banks. Hence, the same profile and email address can be registered from different banks. Unlike current payment systems, embodiments of the payment service permit non-unique ownership of email addresses or mobile phone numbers. Because the registration requirements at banks are different, a situation could exist in which a user has accounts at two banks with the same email address and/or mobile phone number but with slightly different name variations, such as “Thomas J Smith” or “T. J. Smith” or “Tom Smith”. To the payment service these are different, unique names tied to the same email/cell phone number. Another possible case is that of joint accounts in which the same email address is combined with two different names. Or, for that matter, a husband and wife may share an email address and register two completely different accounts at two different banks with the same email address/mobile phone number. The shared payment system and service as disclosed herein accommodates these situations. In various embodiments, a basic condition of the service is that all the customers of the banks will be able to access the service using whatever registration information they currently have with the bank.

The payment service balances this design with the need for the transaction to be delivered uniquely to the correct intended recipient using a unique address. In one case, the unique address is the email address or mobile phone number. So the service is designed to both allow for the non-unique email addresses and at the same time ensure that the payment is delivered to the right person.

The electronic payment or system provides a service and acts as a network in that it is connected to a number of FIs or banks. The retail customers or small business customers of the banks connected to the network of this electronic payment system can make, request and receive payments using the email address or mobile phone number of the other party (payer or creditor). The user can initiate a “send money” or “request money” transaction from within the online banking or mobile banking portal of their bank. The user can send this payment by using the email address or mobile phone number of the second party or the recipient. The second party receives the notification by the method chosen by the sender—either an email or a SMS message. If recipient is already registered for this electronic payment service within their FI (the FI being connected to the electronic payment network), and they have established instructions for the automatic deposit of all payments from this electronic payment service directly into a designated account, then the service deposits the funds into the recipient account, If the recipient is receiving the notification for the first time from this payment service, then they are given instructions in the email about how to receive the funds. The recipient has two choices—if they have an account at a bank that is linked to the electronic payment system and the service is available at their bank, then they can register for the service at their bank, validate their email address or mobile phone number and provide instructions on where to deposit the funds. If the recipient has an account at a bank that is not part of the network of this electronic payment system, then they have the choice of going to a hub or website or mobile banking presence of the electronic payment system and indicate the bank account to which to deposit the funds. This hub site could be co-branded with the bank of the sender. The linkage between the email address or mobile phone address and the account number of the recipient (or the sender) is made at the bank. That information is provided to the electronic payment system. Hence the electronic payment system builds the directory that provides information of the linkage between (1) the sender, his email address or mobile phone number, his account information and (2) the recipient with the recipient's email address, mobile phone number and the recipient's account information at a second bank.

The system has a funds transfer module in it too. The funds transfer module is broadly constructed in that it permits transfers from and to different types of accounts. For example, it can transfer funds from checking or savings accounts to checking and savings accounts. It could also permit transfers from and to debit and credit cards. T Like wise, it could transfer funds to pre-paid cards and gift cards. The system also envisions sending funds internationally. For example, the sender could send money to a recipient overseas using the email address or mobile phone number of the recipient. The same method of enabling the linkage between the sender and the recipient would be followed as described above. In the context, the payment system would be linked to the systems and online and mobile banking site of the banks in foreign countries. The funds would be transferred across the international networks and after appropriate currency exchange be deposited into the account of the recipient.

Like the plurality of source and deposit account types, the system also uses multiple networks based on the type of account used and the settlement time requested by the users. While ACH is a batch system, the system can also use the EFT networks for real-time transfers if that is what the user requests. Similarly, the system is also linked into the debit and credit card networks and will utilize those networks as needed.

So far we have described payment system that provides outbound payment from the payer to the payee. However, the system also has the request-for-pay (RFP) functionality. For business customers, this would be the invoicing capability. In this case, the payee can send a RFP to the payer using the same method of the email address or mobile phone number of the payer. The payer will receive the RFP at their bank site (mobile or online). They can then choose to make their payment or push their payment in response to the RFP. The electronic payment system is able to complete that transaction and without either party knowing anything more than the email or mobile phone number of the other party in the transaction. This also extends to international payments as in outbound payments. In other words, a user can request funds from a payer in another country at their bank overseas and, upon authorization of the payer, the payment system that is linked to banks in the overseas country will transfer the funds and, with appropriate currency exchange, deposit those funds into the account of the payee.

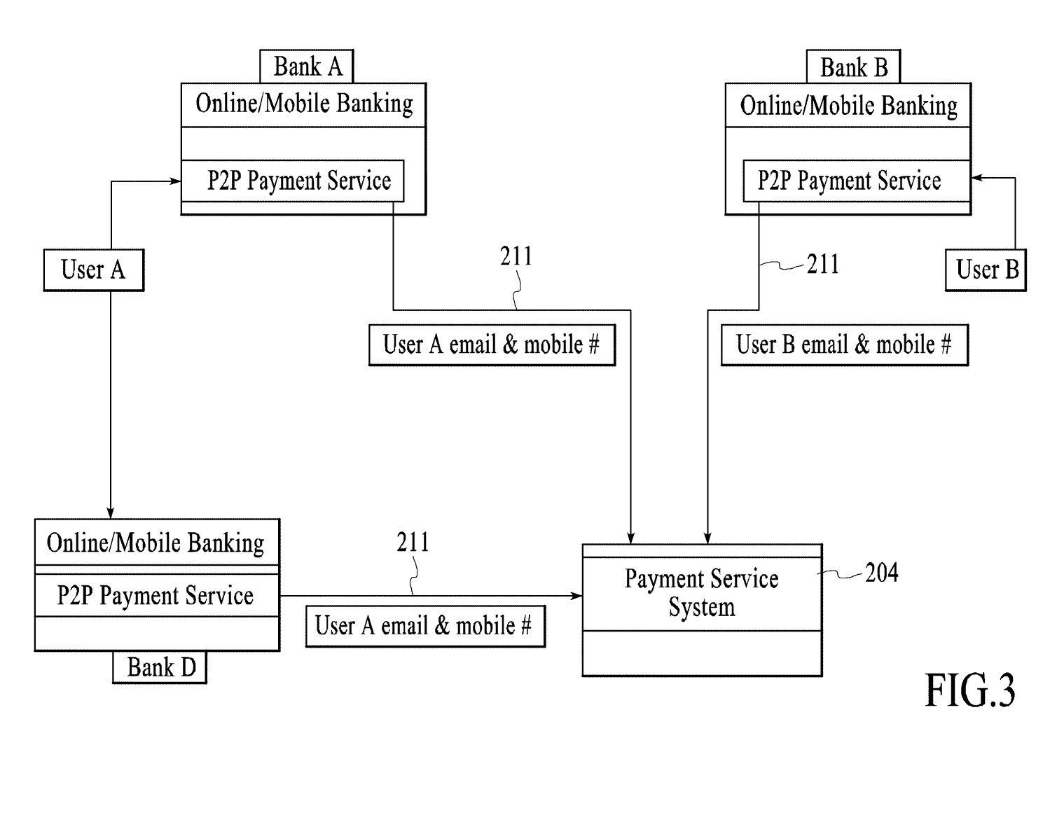

FIG. 3 is a block diagram illustrating the way in which the payment service is embodied in a shared or distributed, third-party architecture. The architecture enables users to send, request and receive money using email addresses or mobile phone numbers. The payment service is provided as a third party service to multiple banks and financial institutions and integrated into the online banking and mobile banking systems of the participating banks and FIs. The payment system is integrated with the online and mobile banking system of Bank A in a seamless way. Customer (or User) A at Bank A can use the service as an option within online and/or mobile banking after they have signed into online or mobile banking using their bank user identification (user ID) and password.

The payment service 204 (refer to FIG. 2) receives registered email (xyz@email1) or mobile phone number (123-456-7890) for Customer A directly from Bank A's systems via proprietary connection 211. In addition, the payment service receives the current account information for the user directly from the bank's systems (e.g. account number, type of account, and balance). Because of this exchange of information between the payment system and Bank A systems, the user (Customer A) can start to use the payment service immediately. In some cases, the user may need to validate access to the email or mobile phone number depending on the bank's requirements.

Customer A can sign up for the payment service from Bank D using the same email address (xyz@email1) and mobile phone number (123-456-7890) from within the online and mobile banking environment of Bank D. In addition, Customer B at Bank B can also sign up for the payment service following a similar method as described above using the same email (xyz@email1) and/or mobile number (123-456-7890). Customer B could be a different person with a different identity.

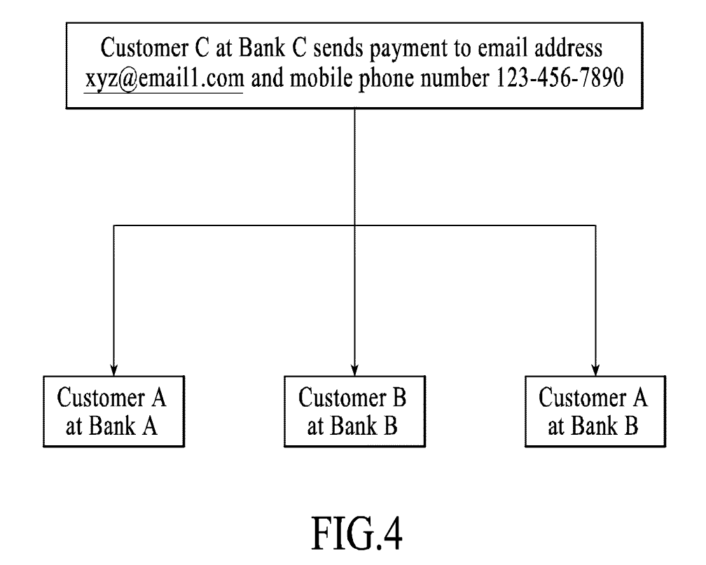

With reference to FIG. 4, Customer A at Bank A will be able to send, request and receive payment using xyz@email1 and 123-456-7890. Customer B at Bank B will also be able to send, request and receive payment using xyz@email1 and mobile number 123-456-7890. When Customer C from another bank (Bank C) using the same P2P service sends a payment or request-to-pay to xyz@email1 or mobile number 123-456-7890, the P2P system will direct that notification to all profiles registered with the P2P service which in this case would be Customer A at Bank A, Customer A at Bank D and Customer B at Bank B. Once the payment is accepted/deposited by one person, the payment will disappear from the other profiles. The payment system ensures, through authentication methods, that the payment was directed to the right payee.

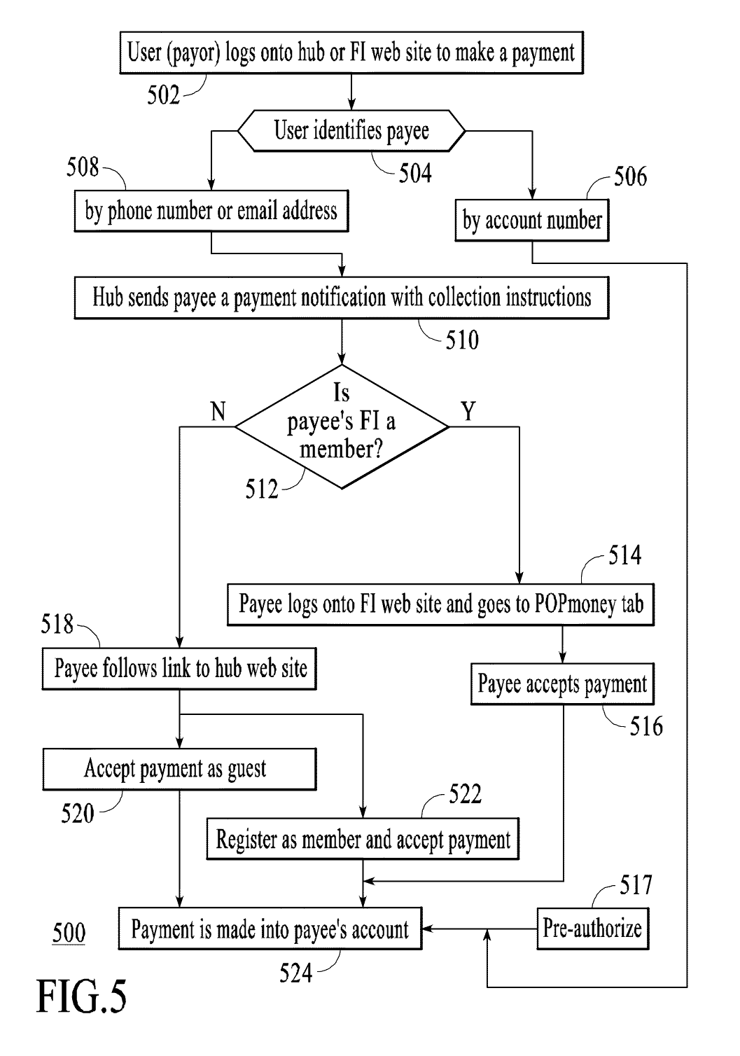

FIG. 5 is a flow diagram of a process 500 of making a payment according to an embodiment of the payment service. At 502 the user (also the payer in this scenario) logs onto the payment service system or FI web site to make a payment. If the FI that the payer wants to use for making the payment is a member of the payment service, the payer can log onto either the system or the FI web site. At 504 the payer requests to make the payment, including identifying the payee. As previously described, the payee may be identified by an account number 506, or by a mobile phone number or email address 508. If the payee is identified by an account number, no further identification is necessary, and the payment is made directly into the identified account at 524. Typically, in the case of a specific payee account number being used as an identification token, the payer and payee have a prior relationship and arrangement such that the payment has been pre-authorized as shown at 517.

If the payee is identified by a mobile phone number or an email address 508, the payment service system uses this identification to send the payee a payment notification with collection instructions at 510. The payee receives an email message or SMS text message saying there is a payment waiting from an identified payer. The message indicates how the payment may be accepted.

The payee is instructed that if the payee's FI is a member of the payment service, as shown at 512, the payee can log onto the FI web site and navigate to a POPmoney tab at 514. Navigating the POPmoney user interface, the payee accepts the payment at 516, and the payment is made into the payee's account at 524.

If the payee's FI is not a member of the payment service, the payee can follow a link to a web site of the payment service at 518. There, the payee may accept the payment as a guest 520, or register as a member of the payment service and accept the payment 522. In either case, after the payment is accepted, the payment is made into the payee's account at 524. The specified payment may of course be rejected rather than accepted. If the payment is not accepted within a certain amount of time (for example some period of days) then the funds for the payment are re-deposited in the source account of the payer. In an embodiment, the funds for the payment are withdrawn from the source account as soon as the payment is requested by the payer. The funds are held in an intermediate account by the financial management system 202 until they are deposited into the destination account of the payee, or are returned to the source account of the payer. In an embodiment, the funds are transferred using an automated clearing house (ACH) network, but embodiments are not so limited.

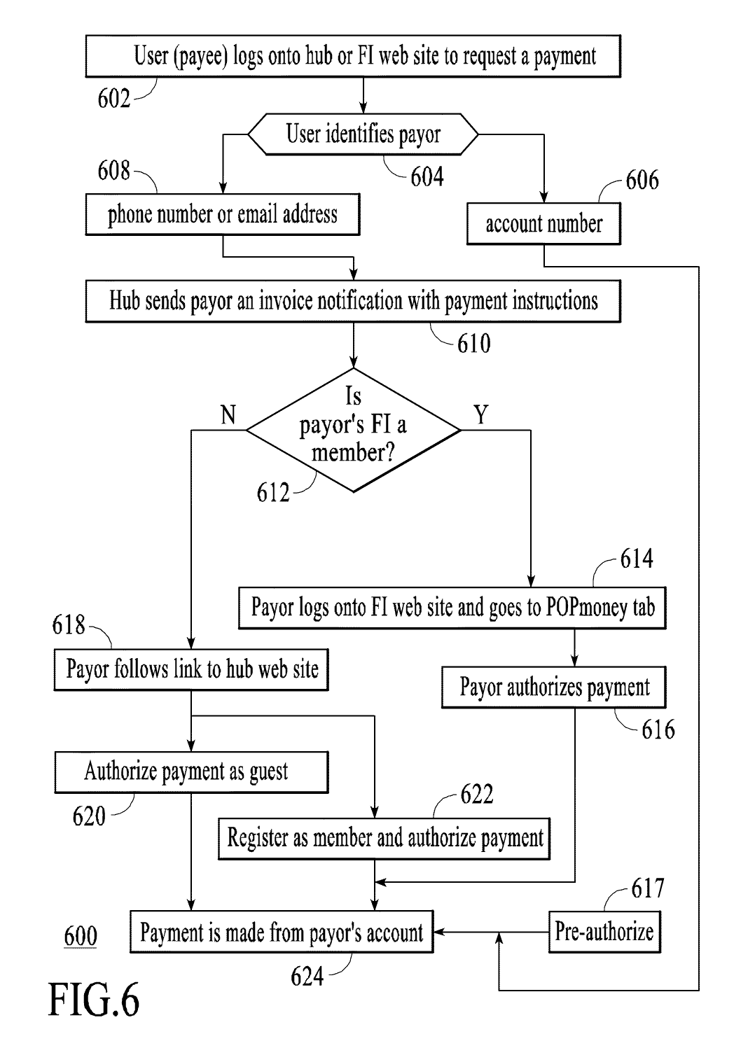

FIG. 6 is a flow diagram of a process 600 of requesting a payment according to an embodiment of the payment service. At 602 the user (also the payee in this scenario) logs onto the payment service system or FI web site to request a payment. If the FI that the payee wants to use for receiving the payment is a member of the payment service, the payee can log onto either the payment service system or the FI web site. At 604 the payee requests the payment, including identifying the payer. As previously described, the payer make be identified by an account number 606, or by a mobile phone number or email address 608. If the payer is identified by an account number, no further identification is necessary, and the payment is made directly to the payee's account from the identified account at 624. Typically, in the case of a specific payer account number being used as an identification token, the payee and payer have a prior relationship and arrangement such that the payment has been pre-authorized as shown at 617.

If the payer is identified by a mobile phone number or an email address 608, the payment service system uses this identification to send the payer an invoice notification with payment instructions at 610. The payer receives an email message or SMS text message saying there is an invoice waiting from an identified payee. The message indicates how the payment may be made.

The payer is instructed that if the payer's FI is a member of the payment service, as shown at 612, the payee can log onto the FI web site and navigate to a POPmoney tab at 614. Navigating the POPmoney user interface, the payer authorizes the payment at 616, and the payment is made from the payer's account at 624.

If the payer's FI is not a member of the payment service, the payer can follow a link to a web site of the payment service system at 618. There, the payer may authorize the payment as a guest 620, or register as a member of the payment service and authorize the payment 622. In either case, after the payment is authorized, the payment funds are withdrawn from the payer's account at 624. The payee is notified of the payment using the method of FIG. 5 or a similar method. If the payment is not accepted by the payee within a certain amount of time (for example some period of days) then the funds for the payment are is re-deposited in the source account of the payer. In an embodiment, the funds for the payment are withdrawn from the source account as soon as the payment is authorized by the payer. The funds are held in an intermediate account by the financial management system 202 until they are deposited into the destination account of the payee, or are returned to the source account of the payer. In an embodiment, the funds are transferred using an automated clearing house (ACH) network, but embodiments are not so limited.

Typically, in the case of a specific payee account number being used as an identification token, the payer and payee have a prior relationship and arrangement such that the payment has been pre-authorized as shown at 617.

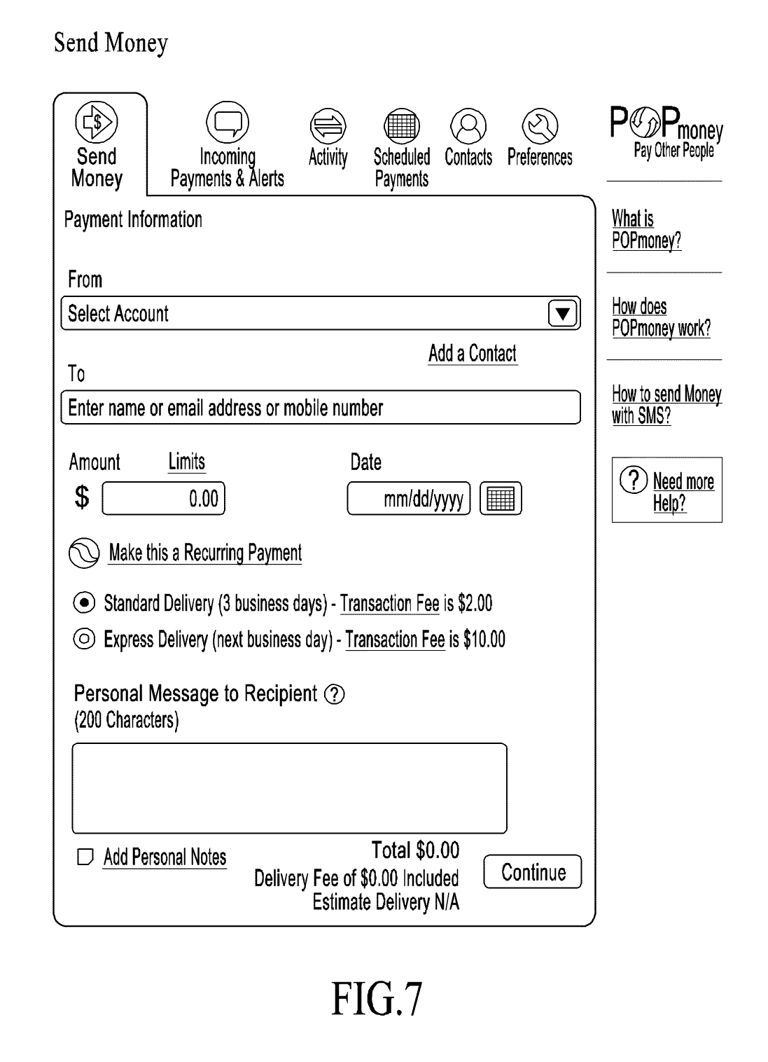

FIG. 7 is an illustration of a user interface “send money” screen of an embodiment of the payment service. FIG. 7 is an example of a screen presented to a user who is a customer of ABC bank. The user can navigate to the ABC home page and log into their accounts with the usual ABC bank user name and password on the ABC bank home page are tabs such as “review accts” and “transfer money”. In addition there is a new tab for the payment service. In the example shown the payment service will be called “POPmoney™”. When the user clicks on POPmoney™ they land on a “send money” page as shown in FIG. 7. Information requested for making the payment include FROM, e.g. from checking account, savings acct, money market acct etc. The user may select an account form accounts displayed in a drop-down menu. TO information is also requested, and can be in the form of an email address, a mobile phone number, or a bank account number. An AMOUNT to be paid is also entered, as is a DATE on which the payment is to be made. The DATE represents a date on which the payment funds are withdrawn from the selected user account. The user may select a method of delivery, including standard delivery or express delivery. There is a transaction fee associated with each method of delivery, and the express (faster) delivery costs more than the standard delivery. The cost amounts shown are examples only.

The user may also choose to make the payment a recurring one. If the “recurring” option is chosen, the user is presented with fields in which to enter a frequency and time duration for the recurring payments, for example “each month for two years”.

The user can enter a personal message to the recipient such as “money for lunch yesterday”. The user can also add a personal note that the payee/recipient will not see, but that might be used to organize or identify the user's transactions. When the user clicks “continue” all of the entered information is presented for review for accuracy, amount, fee, speed of payment, account, etc.

Optionally, a security step follows (not shown) when the user accepts the reviewed payment information. The security step may not occur in every transaction, but if for some reason the transaction request triggers a knowledge-based authentication (KBA), personal questions about the user are presented for answer. The security step could be triggered by, e.g. a high-dollar transaction based on predetermined dollar limit. This limit is typically set by the bank based on the user's history. In addition, the payment service can set a limit on the number of transactions per time period for a user regardless of which, or how many banks or FIs a user requests transactions from (e.g. 10 transactions in 10 hours). In an embodiment the user is presented with a multiple choice test based on information known about the user. If the test is not passed, the payment transaction would not continue.

If the user passes any presented security checks, the payment request process is finished and the user receives a confirmation the payment has been sent. In an embodiment, sending the payment means that the funds have been debited from the specified account, but not yet deposited into the payee's account. Also, a payment notification has been sent to the specified payee/recipient's email address or mobile phone number.

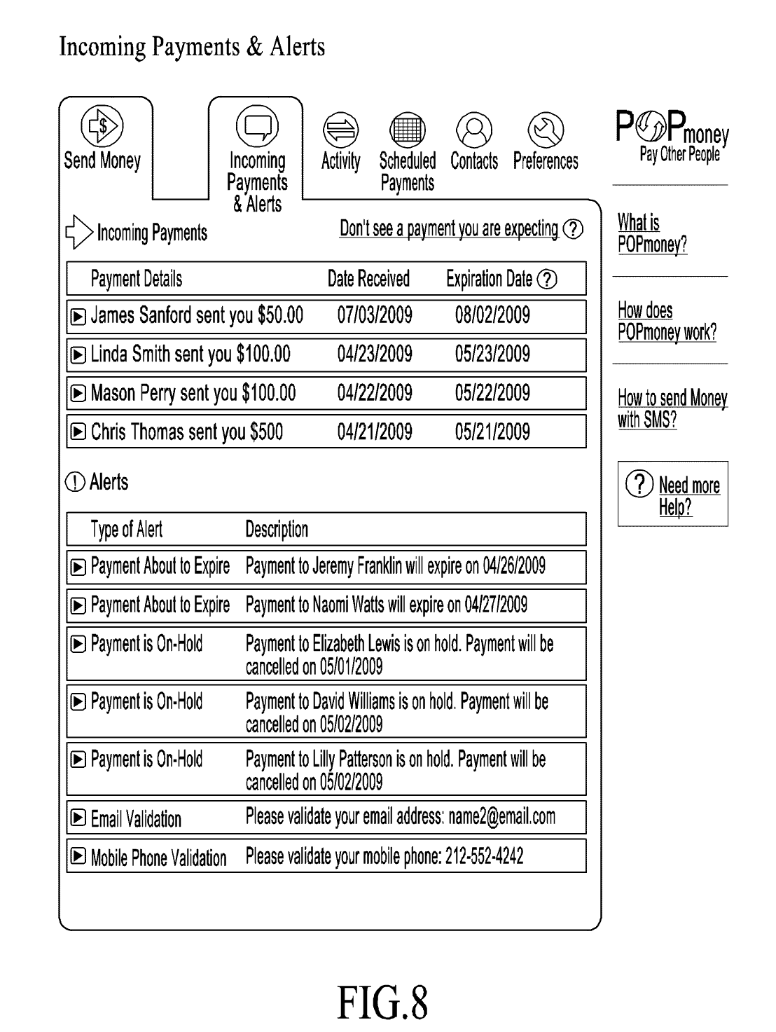

FIG. 8 is an illustration of a user interface page presented when the user clicks an “incoming payments and alerts” tab according to an embodiment. Incoming payments are listed with payer names, amounts, dates received, and expiration dates. As previously described, if payments are not accepted by the payee within a predetermined amount of time, they are re-deposited to the payer's source account. On this page Alerts also appear. Alerts include notices of payments that are about to expire if not accepted, payments that are on hold, and requests to validate token information such as email addresses and mobile phone numbers.

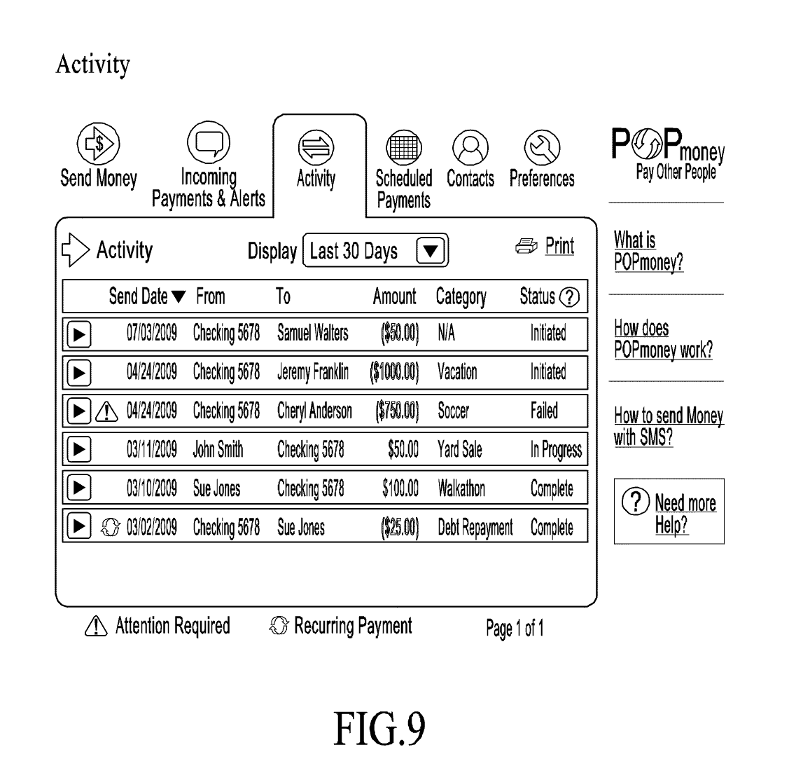

FIG. 9 is an illustration of a user interface page presented when the user clicks an “activity” tab according to an embodiment. A drop-down menu allows the user to choose a time period for which activity is displayed. For each transaction listed, a send date, a source account (belonging to the user/payer), a payee name, and amount, a category (chosen by the user/payer), and a transaction status are displayed.

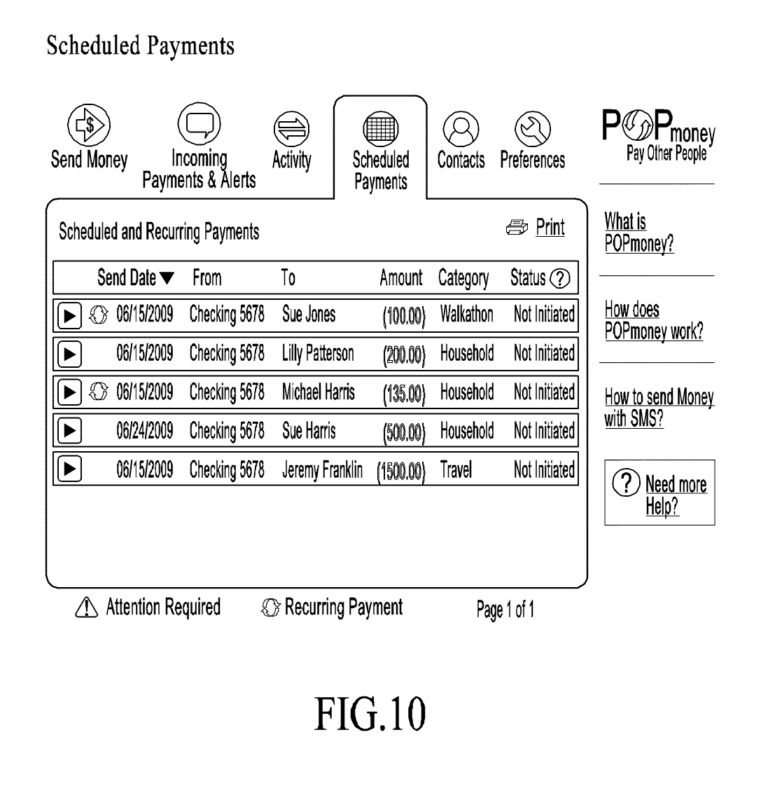

FIG. 10 is an illustration of a user interface page presented when the user clicks a “scheduled payments” tab according to an embodiment. The “scheduled payments” page shows send dates of scheduled payment. Icons displayed by the scheduled send dates indicate whether the payment is a recurring one, and whether there is attention from the user required by the particular payment. For each scheduled payment, the account from which the funds are to be debited, the amount of the payment, a payment category, and a status are also shown. A status of not initiated indicates that the named payee has not yet accepted the payment.

The user interface also includes a “contacts” tab (not shown) which lists individuals and businesses which can be chosen as payees. The contacts information includes email addresses, mobile phone numbers, and/or account numbers for each contact. When the user chooses a payee from the contacts list to be a payee for a scheduled payment, all of the information from the contact page is transferred to the scheduled payment automatically.

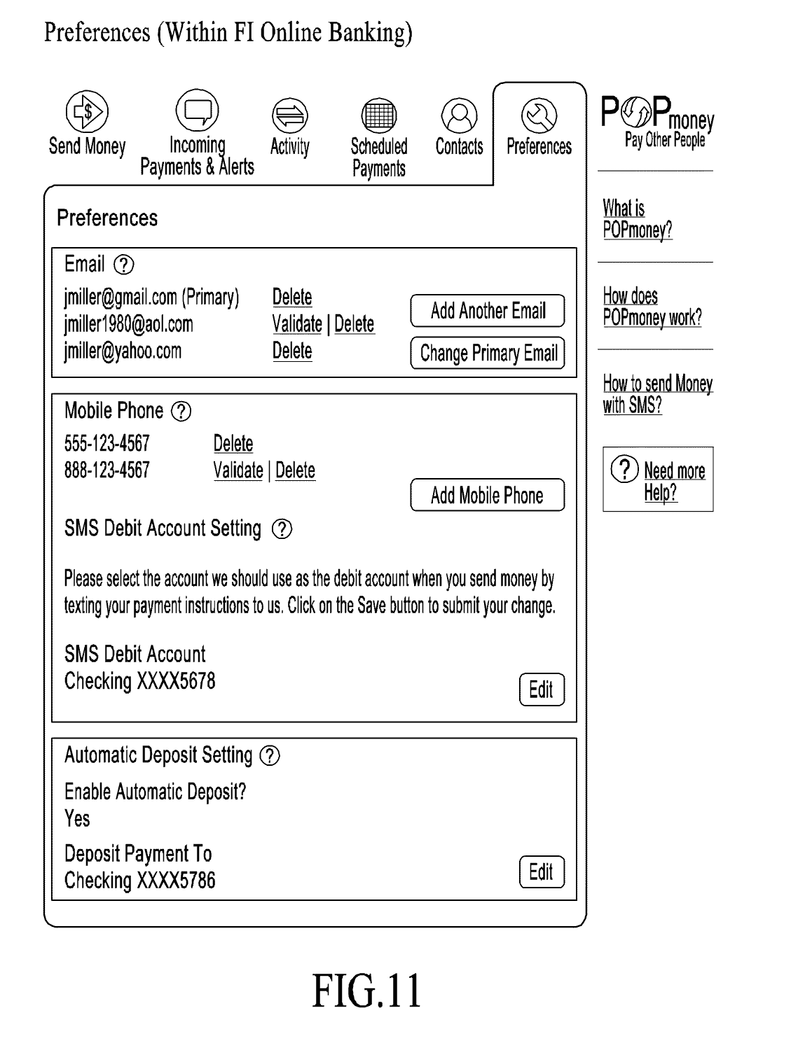

FIG. 11 is an illustration of a user interface page presented when the user clicks a “preferences” tab according to an embodiment. The preferences page of FIG. 11 is visible within the FI online banking POPmoney™ tab. On this page the user/payer may indicate particular information to be used for them within the payment system. The information includes one or more user email addresses, one or more mobile phone numbers, a debit account from which to transfer payment funds, and an automatic deposit option. If the automatic deposit option is chosen, funds received through the payments system are automatically deposited in the indicated account as soon as the payer requests the payment to be made. The payee does not have to accept the payment for the deposit

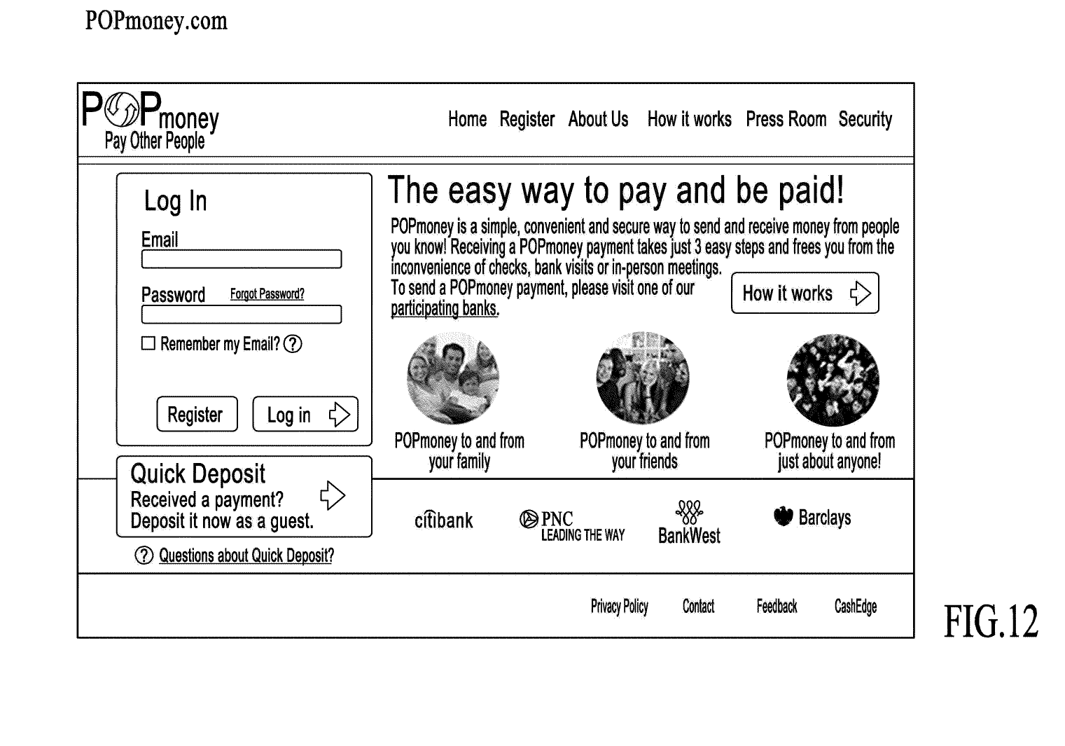

FIGS. 12-21 are illustrations of screens within a user interface of the payment service system, or POPmoney web site in this example. FIG. 12 is an illustration of a home page of the payment service system web site according to an embodiment. A user may visit this home page as a registered user to manage payments. A user may also visit this site through a link in a payment notification although they are not currently a registered user. At the bottom left of the page the visiting user can click a “quick deposit” button to deposit a received payment. The home page includes links to further information about the payment service and several tabs: “Register”, “About Us’, “How It Works”, Press Room”, and “Security”. More or less tabs can be available from the home page in various embodiments.

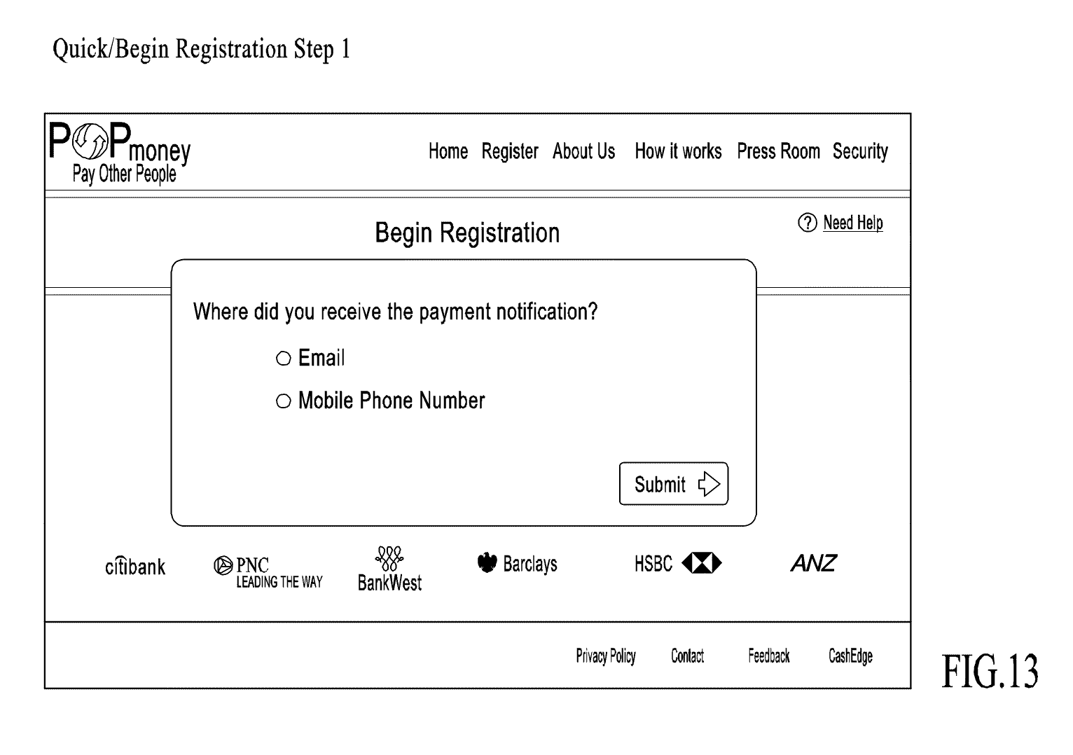

FIG. 13 is an illustration of a registration page reached by clicking the registration tab from the home page. A help button is available if the user is not able to achieve what they would like by simply navigating the page as shown. The user is asked to enter whether they received the payment notification from an email or a mobile phone number.

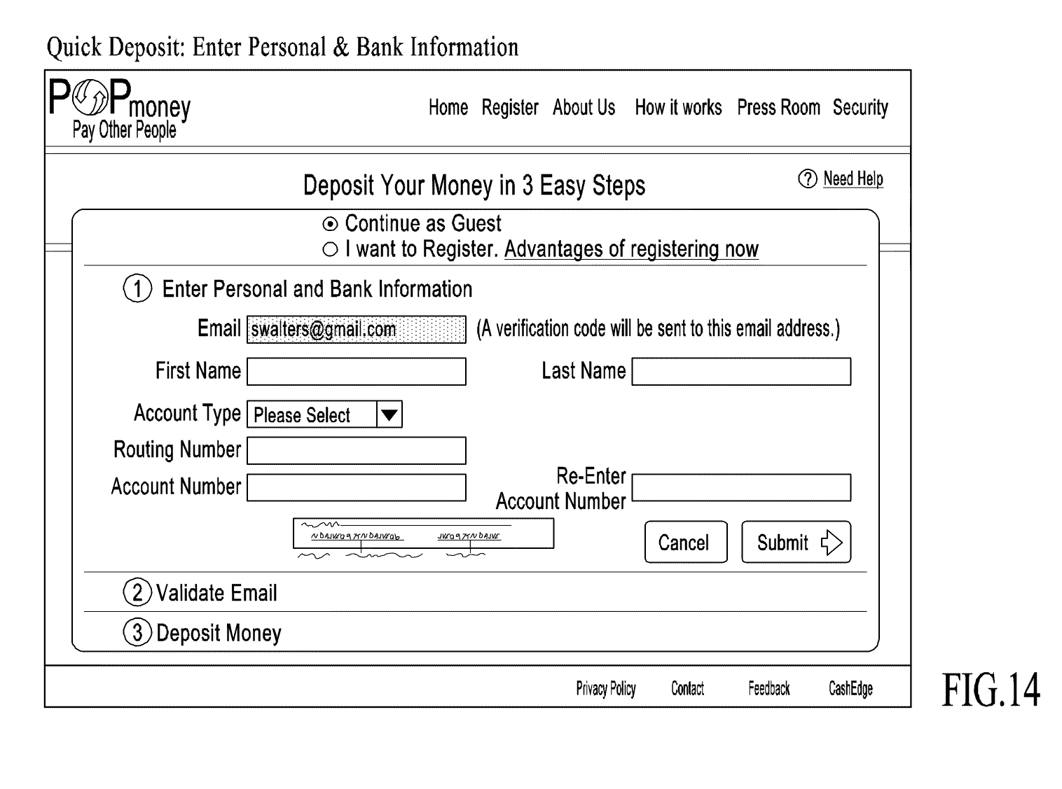

FIG. 14 is an illustration of a “deposit a payment” page the user goes to from the “submit” button on the registration page of FIG. 13. The user can choose whether to register with the service or continue as a guest. When the user chooses to continue as a guest, personal information and banking information is entered as shown in the field labeled “1”. The “2” field, or “validate email” includes a method of validating that the user is the intended recipient to of the payment. For example, the payment service can send the user an email with a code that the user then enters into the system to verify that the user received the code at the identified email address.

If the user enters a bank routing number that is recognized by the payments service as belonging to a member bank, the user can then pick up the payment at the bank instead of at the POPmoney.com web site. In this scenario, the user goes to the bank web site, enters login credentials, and because a smart token sent from the payment service to the bank, is presented with POPmoney tab. This can be a new user who has never use POPmoney before. The user must accept terms and conditions to register for the payment service, and enter required information: email address and mobile phone number. Then this information is entered in the payment service system and the user is sent a code.

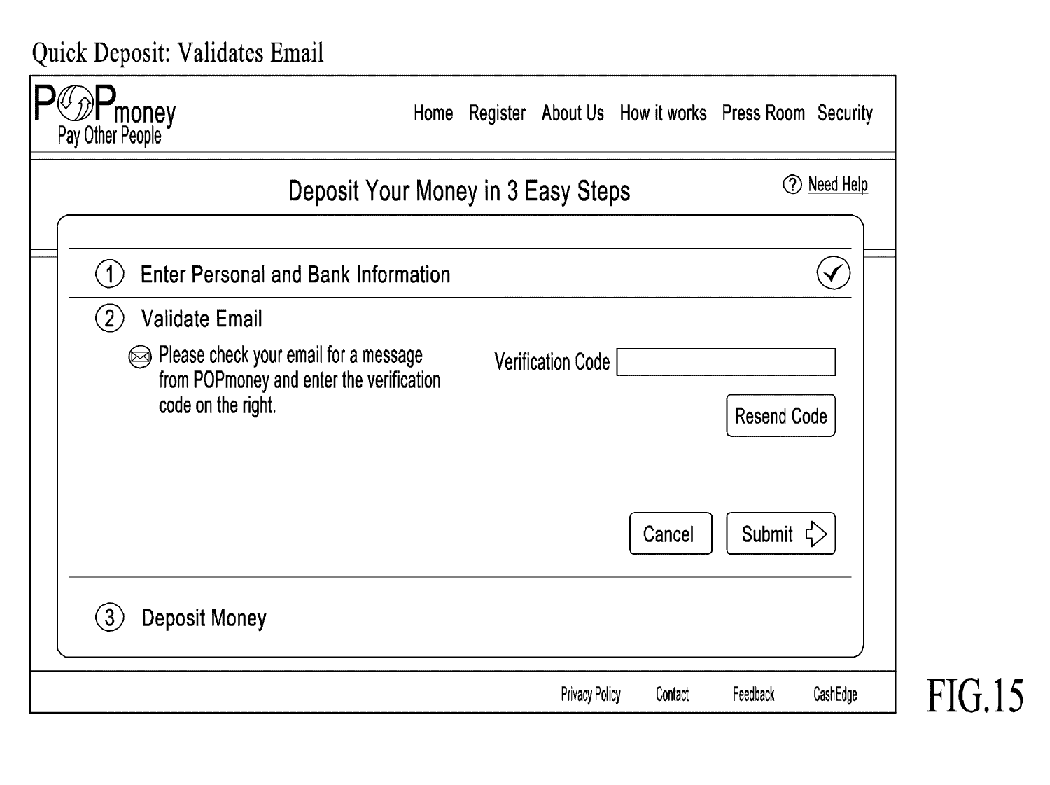

FIG. 15 is an illustration of the page of FIG. 14 after the “validate email” button is clicked. The user can enter the verification code received at the email address and resend the code.

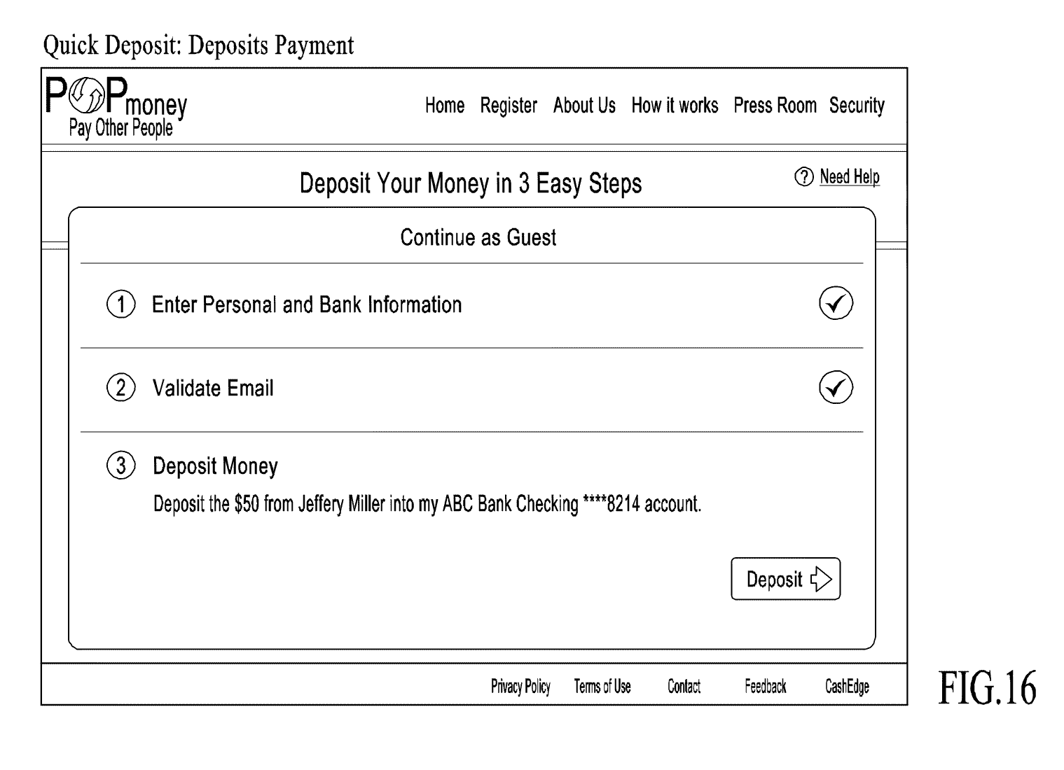

FIG. 16 is an illustration of the page of FIG. 15 showing that steps “1” and “2” have been checked off and the user can now click to deposit the payment into the indicated account.

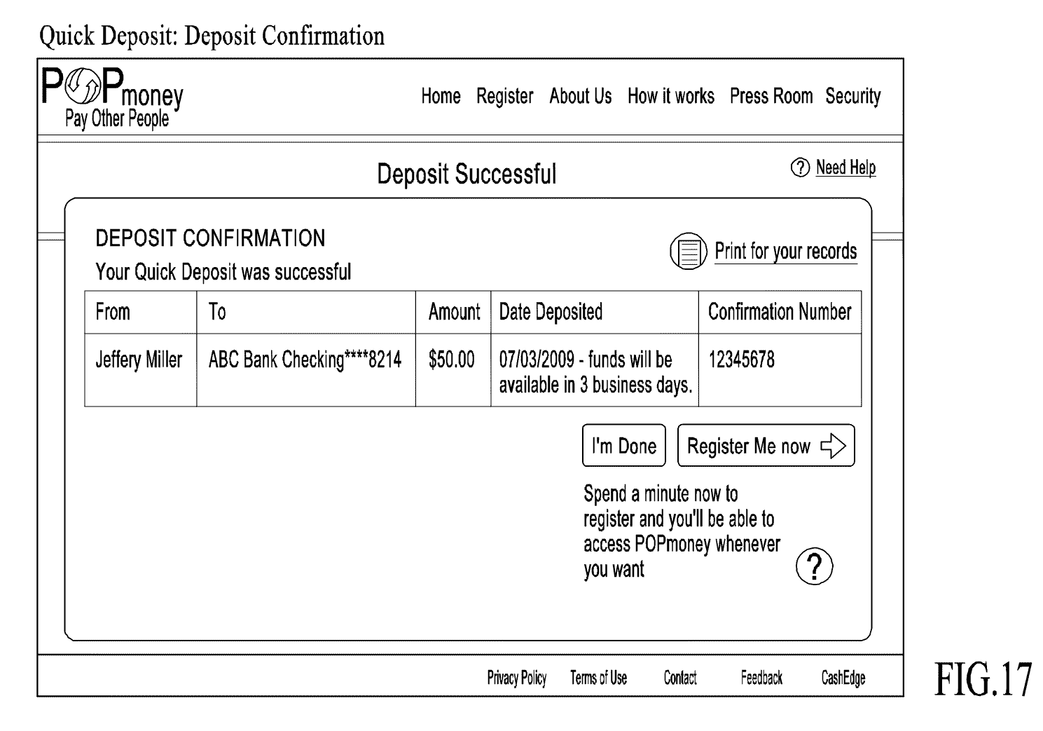

FIG. 17 is an illustration of a “confirmation page” that summarizes details of the successful deposit of the payment. The user is given another opportunity to register with the payment service or simply exit the process.

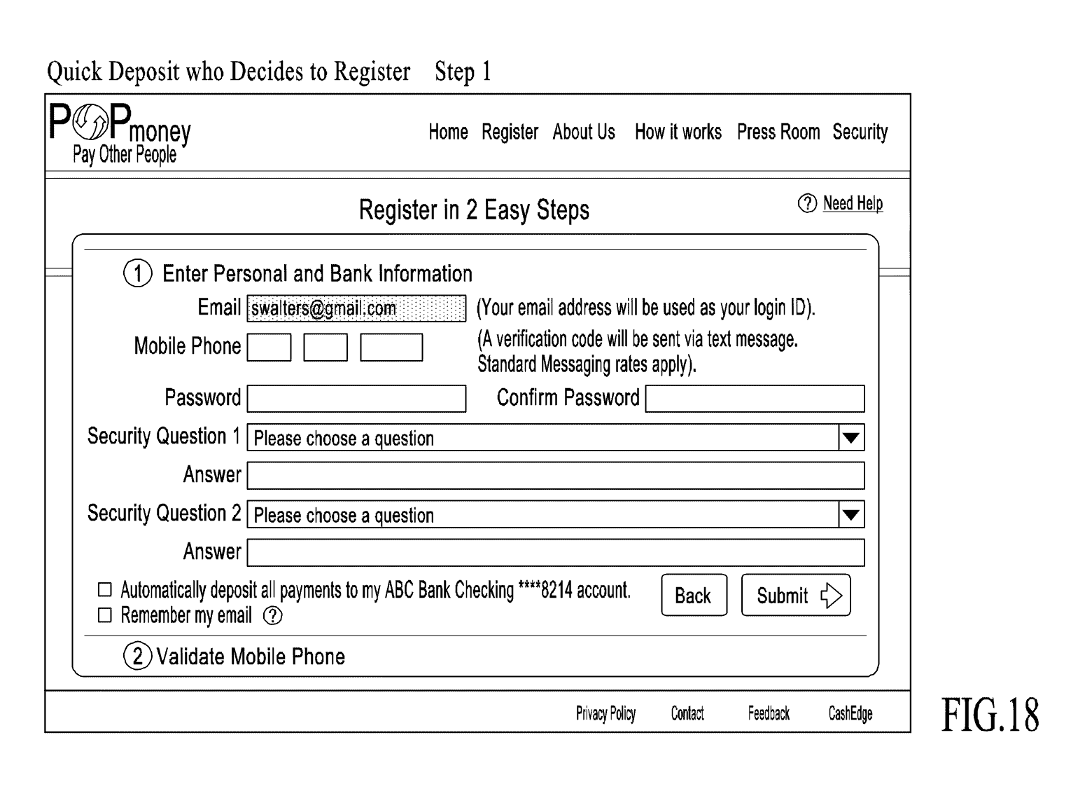

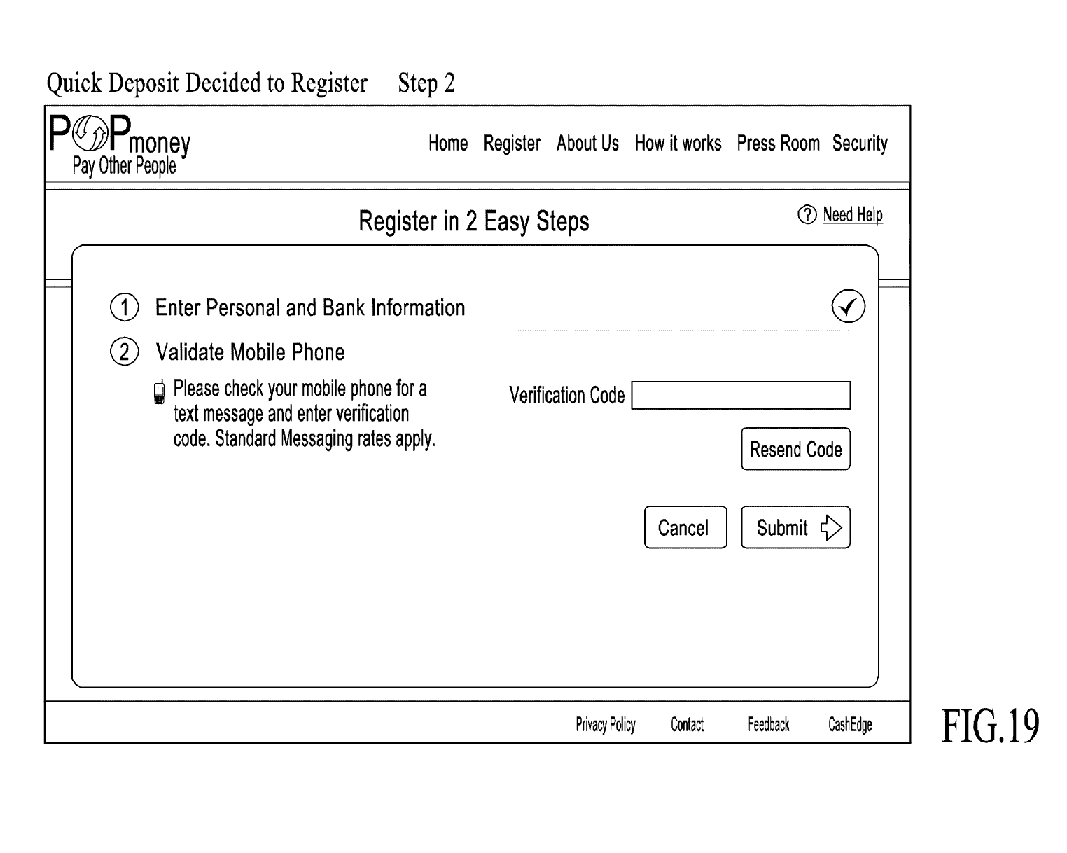

FIG. 18 is an illustration of a “registration” page. The user is asked to enter person information, banking information, and security information. The use is also asks to validate the indicated mobile phone number in a manner similar to that previously described. FIG. 19 is an illustration of a next page in this process showing the mobile phone validation step.

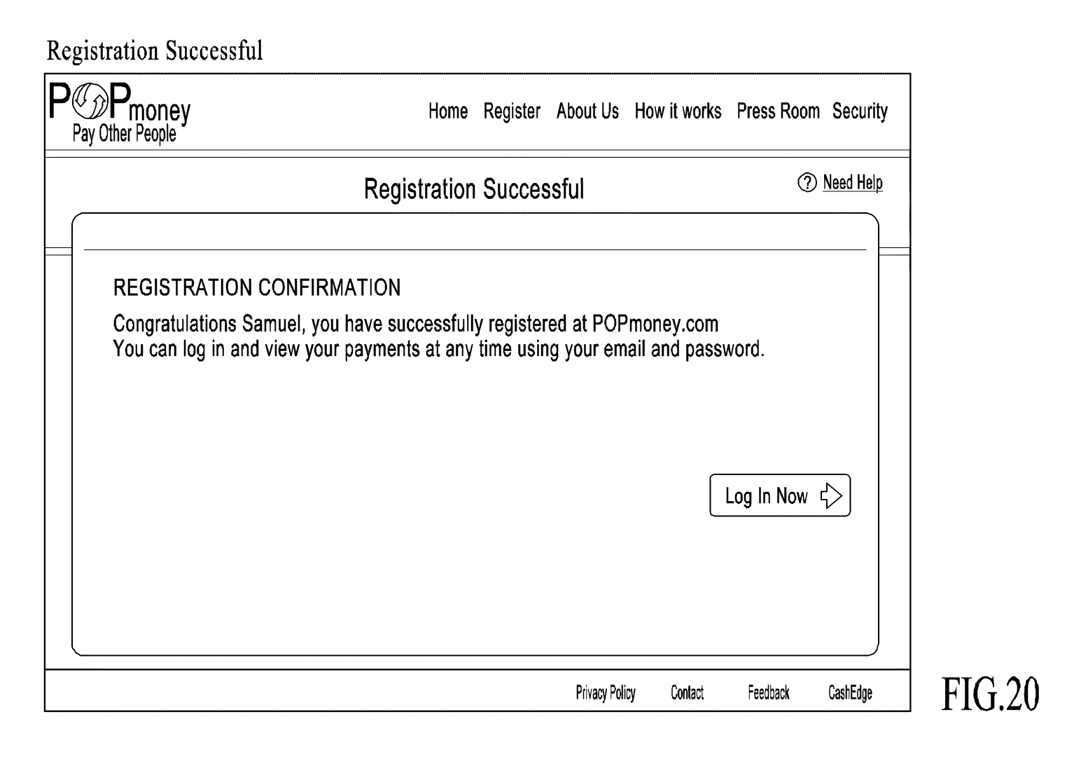

FIG. 20 is an illustration of a “confirmation” page showing that the registration with the payment service was successfully completed.

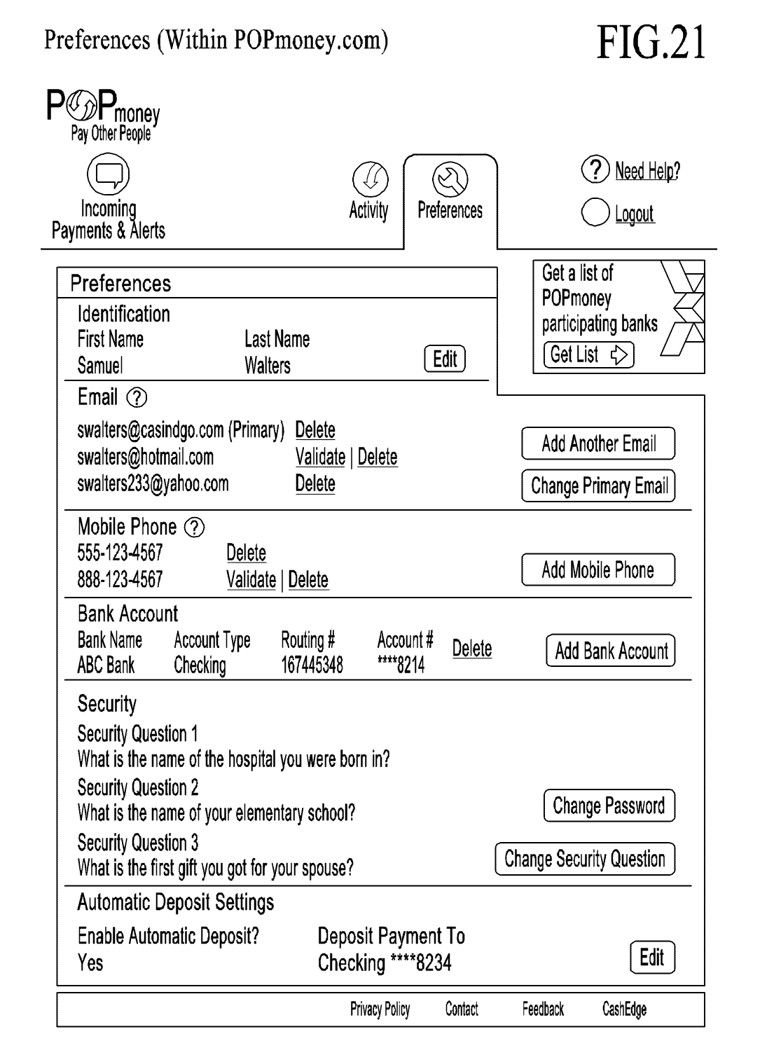

FIG. 21 is an illustration of a “preferences” page within the user interface of the payment service system web site (the POPmoney web site in this example). This page is accessible to the registered user of the payment service, and includes fields in which to enter or change a user name, email preferences, mobile phone preferences, and bank account preferences. This page also includes the security questions for validating the user's identity.

Aspects of the embodiments described above may be implemented as functionality programmed into any of a variety of circuitry, including but not limited to programmable logic devices (PLDs), such as field programmable gate arrays (FPGAs), programmable array logic (PAL) devices, electrically programmable logic and memory devices, and standard cell-based devices, as well as application specific integrated circuits (ASICs) and fully custom integrated circuits. Some other possibilities for implementing aspects of the embodiments include microcontrollers with memory (such as electronically erasable programmable read only memory (EEPROM), Flash memory, etc.), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word, any of the items in the list, all of the items in the list, and any combination of the items in the list.

The above description of illustrated embodiments of the method and system is not intended to be exhaustive or to limit the invention to the precise forms disclosed. While specific embodiments of, and examples for, the method and system are described herein for illustrative purposes, various equivalent modifications are possible within the scope of the invention, as those skilled in the relevant art will recognize. As an example, although the anti-aliasing is generally described herein as an algorithm executed on hardware as a series of steps, the steps may be executed in an order other than the order described. In addition, the particular hardware or software components named, such as drivers, depth buffer, etc. are not meant to be exclusive or limiting.

The various operations described may be performed in a very wide variety of architectures and distributed differently than described. In addition, though many configurations are described herein, none are intended to be limiting or exclusive.

In general, in the following claims, the terms used should not be construed to limit the method and system to the specific embodiments disclosed in the specification and the claims, but should be construed to include any processing systems and methods that operate under the claims. Accordingly, the method and system is not limited by the disclosure, but instead the scope of the method and system is to be determined entirely by the claims.

While certain aspects of the method and system are presented below in certain claim forms, the inventors contemplate the various aspects of the method and system in any number of claim forms. For example, while only one aspect of the method and system may be recited as embodied in computer-readable medium, other aspects may likewise be embodied in computer-readable medium. Computer-readable media include any data storage object readable by a computer including various types of compact disc: (CD-ROM), write-once audio and data storage (CD-R), rewritable media (CD-RW), DVD (Digital Versatile Disc” or “Digital Video Disc), as well as any type of known computer memory device. Such computer readable media may store instructions that are to be executed by a computing device (e.g., personal computer, personal digital assistant, PVR, mobile device or the like) or may be instructions (such as, for example, Verilog or a hardware description language) that when executed are designed to create a device (GPU, ASIC, or the like) or software application that when operated performs aspects described above. Accordingly, the inventors reserve the right to add additional claims after filing the application to pursue such additional claim forms for other aspects of the method and system.

What is claimed is:

1. An electronic payment system, comprising:
a financial management system communicatively coupled to a plurality of financial institutions (FIs);
a database configurable to store information regarding the plurality of FIs and information comprising a plurality of users, wherein each of the plurality of users owns accounts at least one of the FIs;
a payment service system coupled to the plurality of FIs, the payment service system configurable to use information stored in the database to perform payment services, wherein performing comprises,
receiving a request for a payment transaction from a first user, wherein the request comprises a request to make a payment and a request for payment to be made;
receiving an identification of a second user from the first user, wherein the second user comprises a recipient of the payment or a payer of the payment, and wherein the identification of the second user is associated in the database with at least one of the plurality of FIs; and
sending a notification of the request to the second user based on the identification, including sending the request to multiple FIs when the identification is associated with more than one FI.

2. The system of claim 1, wherein the payment service system is further configurable to:
receive a response to the notification from the second user, wherein the response is electronically sent by the second user with the identification; and
determining an origin of the response, comprising determining an origin FI the identification is associated with; and
disabling notifications sent to any FIs other than the origin FI.

3. The system of claim 1 further comprising a funds transfer module configurable to execute the payment transaction.

4. The system of claim 3 wherein the transaction comprises:
debiting an account of the first user;
crediting a central clearing account at an intermediate FI;
debiting the central clearing account; and
crediting an account identified by the second user.

5. The system of claim 4, wherein the transaction comprises using an automated clearing house (ACH) network.

6. The system of claim 4, wherein the transaction comprises using an automated teller machine (ATM) network.

7. The system of claim 4, wherein the transaction comprises using a credit card network.

8. The system of claim 4, wherein the account of the first user is a checking account.

9. The system of claim 4, wherein the account of the first user is a loan account.

10. The system of claim 4, wherein the account of the first user is a debit card account.

11. The system of claim 4, wherein the account of the first user is a credit card account.

12. The system of claim 4, wherein the account of the first user is a pre-paid card account.

13. An electronic payment system, comprising:
a financial management system communicatively coupled to a plurality of financial institutions (FIs);
a database configured to store information regarding the plurality of FIs and information comprising a plurality of users, wherein each of the plurality of users owns accounts at least one of the FIs;
a payment service system coupled to the plurality of FIs, the payment service system configurable to use information stored in the database to perform payment services, wherein performing comprises,
receiving a request for a payment transaction from a first user, wherein the request comprises a request to make a payment and a request for payment to be made;
receiving an identification of a second user from the first user, wherein the second user comprises a recipient of the payment or a payer of the payment; and
sending a notification of the request to the second user based on the identification, the notification comprising a link to a user interface of the payment service system;
receiving input from the second user through the user interface in response to the notification, including information regarding an FI at which the second user has an account and which the second user chooses to participate in the payment transaction.

14. The system of claim 13, wherein the payment service system is further configurable to:
associate the identification of the second user with the FI chosen by the second user; and
associate the same identification of the second user with additional FIs chosen by the second user, wherein the second user owns accounts at the additional FIs.

15. The system of claim 14, further comprising a funds transfer module configurable to execute the payment transaction.

16. The system of claim 15, wherein the transaction comprises:
debiting an account of the first user;
crediting a central clearing account at an intermediate FI;
debiting the central clearing account; and
crediting an account identified by the second user.

17. The system of claim 16, wherein the transaction comprises using an automated clearing house (ACH) network.

18. The system of claim 16, wherein the transaction comprises using an automated teller machine (ATM) network.

19. The system of claim 16, wherein the transaction comprises using a credit card network.

20. The system of claim 16, wherein the account of the first user is a checking account.

21. The system of claim 16, wherein the account of the first user is a loan account.

22. The system of claim 16, wherein the account of the first user is a debit card account.

23. The system of claim 16, wherein the account of the first user is a credit card account.

24. The system of claim 16, wherein the account of the first user is a pre-paid card account.

25. A system comprising:
a financial management system coupled to a network, the financial management system comprising,
a database configurable to store information regarding a plurality of financial institutions (FIs) coupled to the network and information comprising a plurality of users, wherein each of the plurality of users owns accounts at least one of the FIs; and
a payment service system coupled to the plurality of FIs, the payment service system configurable to use information stored in the database to perform payment services, wherein performing comprises,
associating an identification of a user with each of the FIs at which the user owns accounts, wherein more than one user may have an identical identification at a same FI;
receiving a requests for a payment transaction, wherein the request is originated by a first party to the requested payment transaction through one of a user interface of the financial management system and a user interface of one of the plurality of FIs, wherein the request includes an identification of a second party to the requested payment transaction; and
based on the request, notifying the second party of the request.

26. The system of claim 25, wherein first party is a registered user of the payment services system, and the database stored first party information, including FI information and payment transaction preference information

27. The system of claim 26, wherein the second party is not a registered user of the payment services system, and wherein the notification is sent via one of an email message and a short message service (SMS) message.

28. The system of claim 26, wherein the second party is a registered user of the payment service and wherein the notification is sent via one of an email message and a short message service (SMS) message.

29. The system of claim 28, wherein the second party communicates with the payment services system to authorize the payment transaction using one of the user interface of the financial management system and a user interface of one of the plurality of FIs that is associated with the second user in the database.

30. The system of claim 28, wherein the payment transaction preferences include automatically executing the requested payment transaction based on a prior authorization by the second party

31. The system of claim 25 further comprising a funds transfer module configurable to execute the payment transaction.

32. The system of claim 31, wherein the transaction comprises:
debiting an account of the first party;
crediting a central clearing account at an intermediate FI;
debiting the central clearing account; and
crediting an account identified by the second party.

33. The system of claim 32, wherein the transaction comprises using an automated clearing house (ACH) network.

34. The system of claim 32, wherein the transaction comprises using an automated teller machine (ATM) network.

35. The system of claim 32, wherein the transaction comprises using a credit card network.

36. The system of claim 32, wherein the account of the first user is a checking account.

37. The system of claim 32, wherein the account of the first user is a loan account.

38. The system of claim 32, wherein the account of the first user is a debit card account.

39. The system of claim 32, wherein the account of the first user is a credit card account.

40. The system of claim 32, wherein the account of the first user is a pre-paid card account.
